(19) United States
(12) Patent Application Publication
(10) Pub. No.: US 2023/0115160 A1
(43) Pub. Date: Apr. 13, 2023

(54) VEGETATION ATTACHMENT DEVICE

(71) Applicant: Bigelow Brook Farm, LLC, Eastford, CT (US)

(72) Inventor: Robert J. Torcellini, Eastford, CT (US)

(21) Appl. No.: 17/500,861

(22) Filed: Oct. 13, 2021

(51) Int. Cl. A01G 9/12

(52) U.S. Cl. CPC A01G 9/128; A01G 9/126

(57) ABSTRACT

A vegetation attachment device, includes a foldable, bendable or rollable planar sheet of material with a center portion configured as a narrow band; edges of the planar sheet of material include one or more of a notch, a slot, a groove, and a recess; at least one of the recesses is positioned for placement of a supporting string, cable, or wire; and at least one of the recesses is positioned for affixing to a supporting structure, including one of a cage, a trellis, and a net.

### BACKGROUND OF THE DISCLOSURE

### Field of the Disclosure

The present disclosure generally relates to devices for fastening plants, and more particularly to a device for fastening plant material, such branches, stems, vines, and the like, to a supporting trellis, such as strings, cables, nets of various materials, and the like.

### Discussion of the Background

In recent years, various agriculture and horticultural settings employ the use of support structures, such as trellises, nets, strings, or cables to support plant materials. Plants with varying architecture, such as bushy, vining, and indeterminate plants, such as tomatoes, cucumbers, and certain melons, frequently require support structures and associated fastening devices. The primary devices used to attach and support plants are plastic retaining clips, metal bands, or hook and loop strips. Not only does the structure of many such conventional devices make them difficult to implement, remove, and reuse, but the materials from which these devices are manufactured limit the ability to quickly dispose of the plant for composting at the end of the production cycle. This frequently results in either the disposal of the plant material and associated devices into municipal waste systems, or the introduction of non-degrading materials into composting systems and local environments.

### SUMMARY OF THE DISCLOSURE

Therefore, there is a need for devices that addresses the above and other problems. The above and other problems are addressed by the illustrative embodiments of the present disclosure, where there is provided a fastening device that is initially a relatively flat component that can, for example, be constructed of biodegradable material, and the like. The device can be bent or folded, and the like, around a portion of a plant, such as a stem, vine, and the like, and intertwined into a support structure, such an overhead drop-string, and the like. Advantageously, either at the end of the plant growth cycle, or during regular pruning or maintenance, the plant material, and associated supporting string and fastening devices can be easily removed and discarded, and when constructed from biodegradable material, disposal into a composting area can eliminate the expense of disposing excess material through municipal waste services, and the like.

Accordingly, in illustrative aspects of the present disclosure there is provided a vegetation attachment device, includes a foldable, bendable or rollable planar sheet of material with a center portion configured as a narrow band; edges of the planar sheet of material include one or more of a notch, a slot, a groove, and a recess; at least one of the recesses is positioned for placement of a supporting string, cable, or wire; and at least one of the recesses is positioned for affixing to a supporting structure, including one of a cage, a trellis, and a net.

The planar sheet of material includes one or more of chipboard material, paper material, and plastic polymer material.

The planar sheet of material is biodegradable.

The planar sheet of material is substantially flexible.

The planar sheet of material is coated with a protective substance.

At least one of the recesses is positioned to allow the device to rotate along a horizontal axis while maintaining the containment of the supporting string, cable, wire, or supporting structure, such as a cage, trellis, or net.

The device includes a series of score marks or perforations.

The device further includes orientation indicators.

The orientation indicators are tactile orientation indicators.

The orientation indicators are printed on the device.

The device further includes one or more devices attached to a supporting string, and horizontal rotation of each of the devices shortens a vertical distance between each device, aiding in distributing the bearing weight throughout each device.

The device is manufactured by one of rotary die cutting, laser die cutting, injection molding, and 3D printing.

Still other aspects, features, and advantages of the present disclosure are readily apparent from the following detailed description, by illustrating a number of illustrative embodiments and implementations, including the best mode contemplated for carrying out the present disclosure. The present disclosure is also capable of other and different embodiments, and its several details can be modified in various respects, all without departing from the spirit and scope of the present disclosure. Accordingly, the drawings and descriptions are to be regarded as illustrative in nature, and not as restrictive.

### BRIEF DESCRIPTION OF THE DRAWINGS

The embodiments of the present disclosure are illustrated by way of example, and not by way of limitation, in the figures of the accompanying drawings and in which like reference numerals refer to similar elements and in which:

FIG. 1 is a front view illustrating the device in its original, relatively flat orientation;

FIG. 2 is a perspective view illustrating the device when bent into the final form;

FIG. 3 is a close-up perspective view of the device attached to a supporting string including a plant stem;

FIG. 4 is a close-up perspective view of the reverse side of the device attached to a supporting string including a plant stem;

FIG. 5 is a close-up perspective view of the device displaying the supporting string intertwined through the device;

FIG. 6 is a perspective view of multiple devices attached to a supporting string including a plant stem; and

FIG. 7 is a perspective view of multiple devices creating tension on the supporting string as the plant and stem includes additional weight;

FIG. 8 is a perspective view of a dispensing unit;

FIG. 9 is a perspective view of the dispensing unit of FIG. 8, including multiple devices;

FIG. 10 is a perspective view of the dispensing unit of FIG. 8, including multiple devices, with a device being removed from the dispensing unit;

FIG. 11 is a side view illustrating the dispensing unit of FIG. 8 with a device being removed from the dispensing unit; and

FIG. 12 is a top view illustrating the dispensing unit of FIG. 8, including multiple devices, with a device being removed from the dispensing unit.

### DETAILED DESCRIPTION OF THE PREFERRED EMBODIMENTS

The following detailed description and accompanying drawings are intended as descriptions of various embodiments of the disclosed disclosure and are not intended to represent the only embodiments. Each embodiment described in this disclosure is intended to describe aspects of the disclosure in sufficient detail to enable those skilled in the art to practice the disclosure. Other embodiments can be utilized, and changes can be made without departing from the scope of the present disclosure. The illustrative examples provided herein are not intended to be exhaustive or to limit the claimed subject matter to the precise forms disclosed. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except, as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The articles “a” and “an”, used here, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or features, and may have a single or plural connotation depending upon the context in which it is used. The adjective “any” means one, some, or all indiscriminately or whatever quantity.

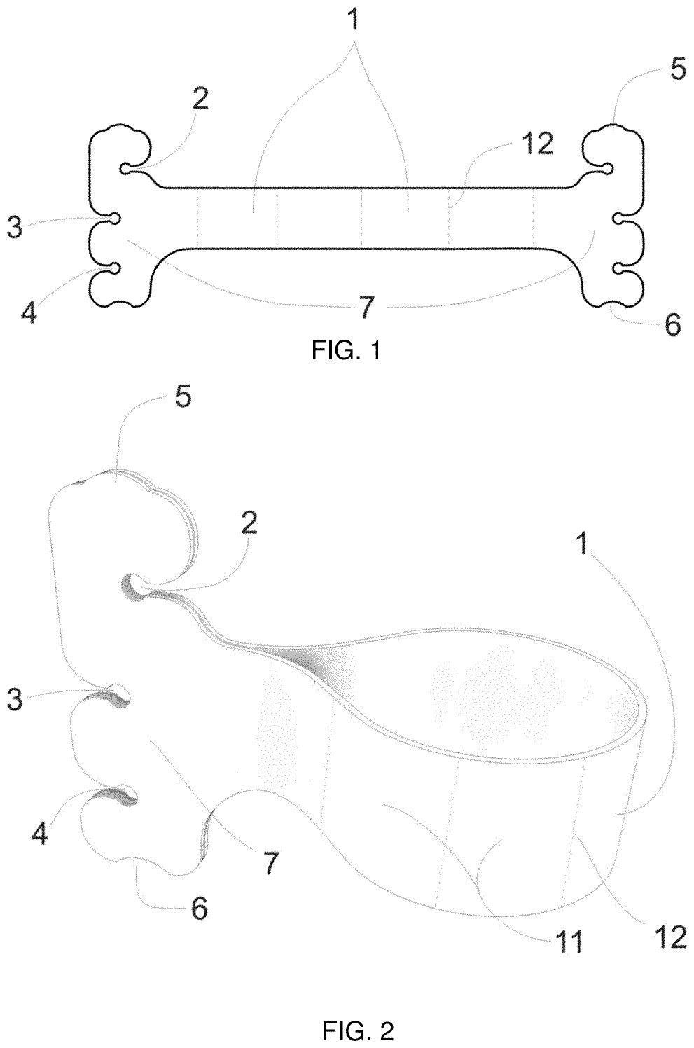

Referring now to the drawings, wherein like reference numerals designate identical or corresponding parts throughout the several views, and more particularly to FIG. 1 thereof, there is shown a front-view illustration of the disclosure, in the original form, prior to attachment to a support string, while FIG. 2 provides a perspective view of the disclosure after being bent into a final form. The main band 1 is bent in a manner as to bring the two outer wings 7 into contact with each other whereas attachment points 2, 3, and 4 for the support string are in alignment. Score lines or perforations 12 may be utilized to assist with accurate bending. The tab 5 and indent 6 provide visual and tactile indicators to represent the proper orientation that the device will be placed on a supporting string.

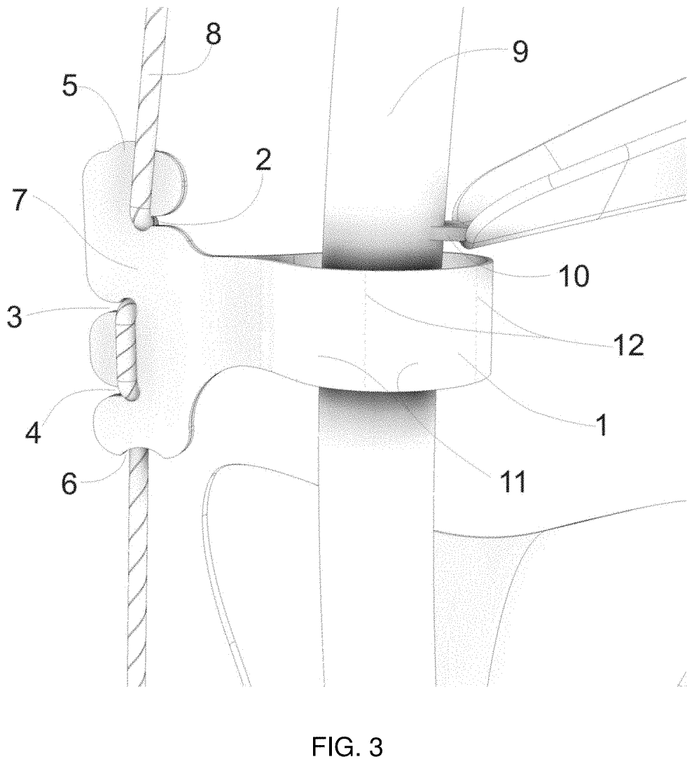

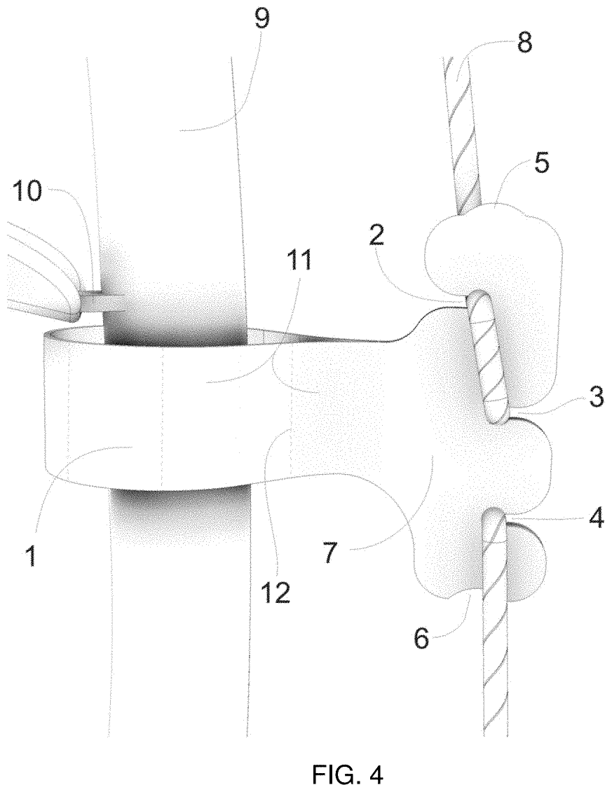

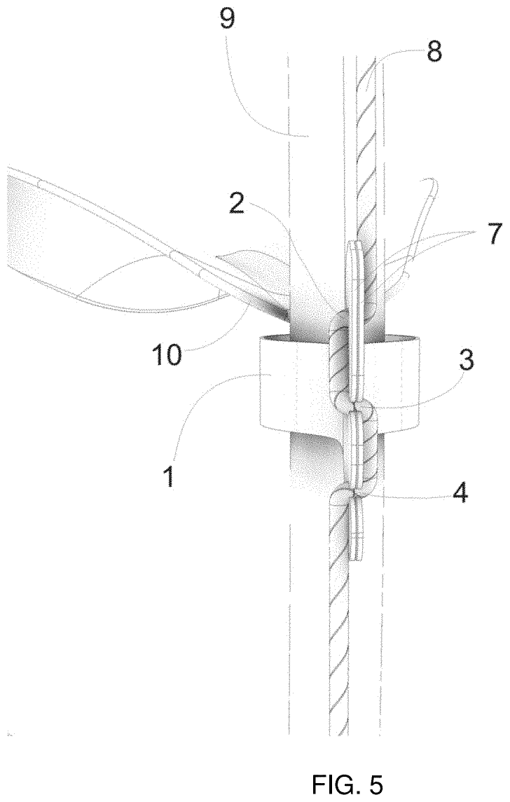

With reference to the drawings, and particularly with reference to FIGS. 3, 4, and 5 which provide perspective views of the embodiment as it includes and supports the stem of a plant: The main band 1 of the embodiment is bent around the stem 9 and can be near or contacting an outcropping stem or leaf 10. The two outer wings 7 are in contact with each other and the attachment points 2, 3, and 4 are aligned with the opposing wing. The supporting string 8 is slid through into the slot at the top point 2, then through the slot of the middle point 3, and then through the slot of the bottom point 4. The alternating pattern of the string through the embodiment reduces the risk of the embodiment changing the placement along the string.

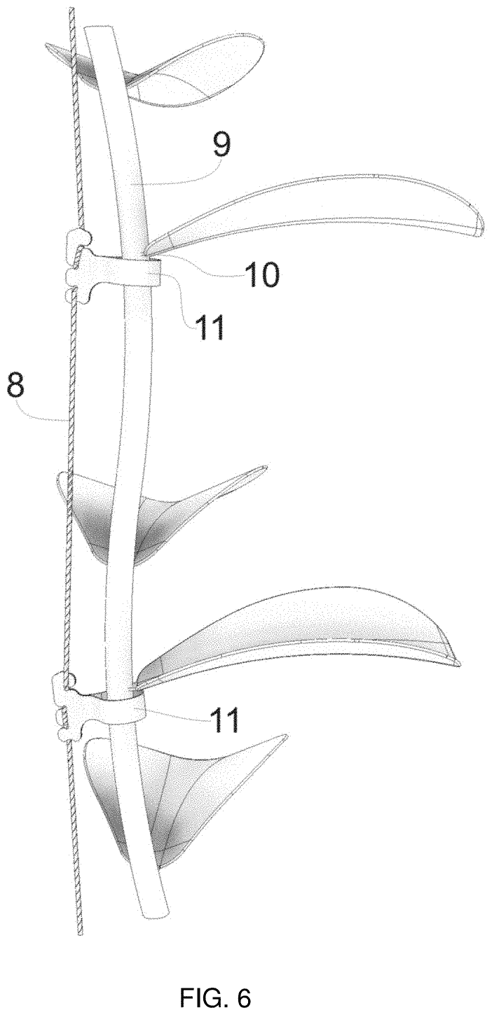

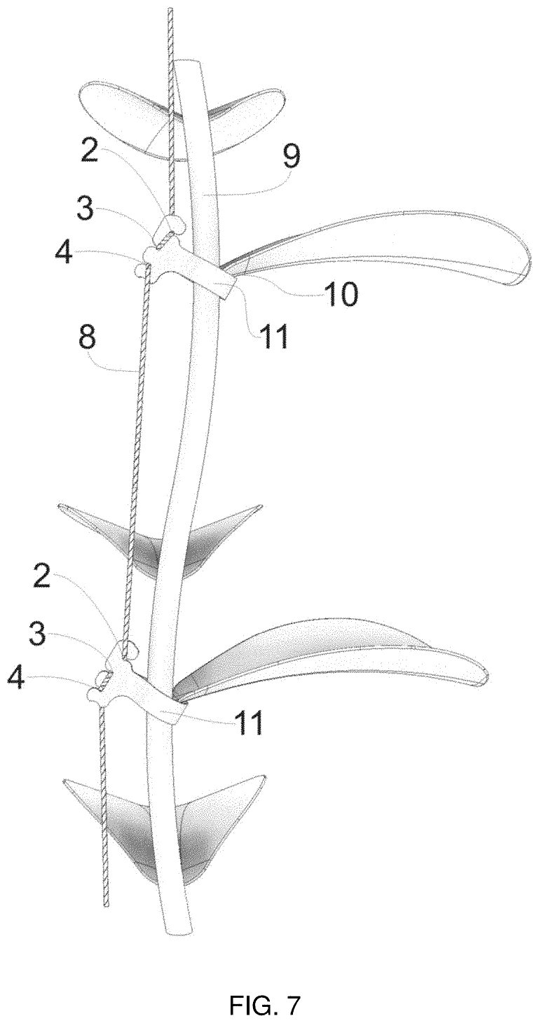

With reference to the drawings, and particularly with reference to FIGS. 6 and 7 which provide perspective views of multiple embodiments including the stem of a plant: As the fasteners 11 are placed under a stem or leaf 10, the weight of the entire plant 9 is distributed onto each fastener 11. The fastener rotates around the string containment point 3 whereas the overall vertical distance of the supporting string 8 is shortened which aids to distribute the weight of the plant 9 between the series of embodiments. The position of the string containment points 2 and 4 are positioned in the device to prevent the supporting string 8 from slipping out of the embodiment.

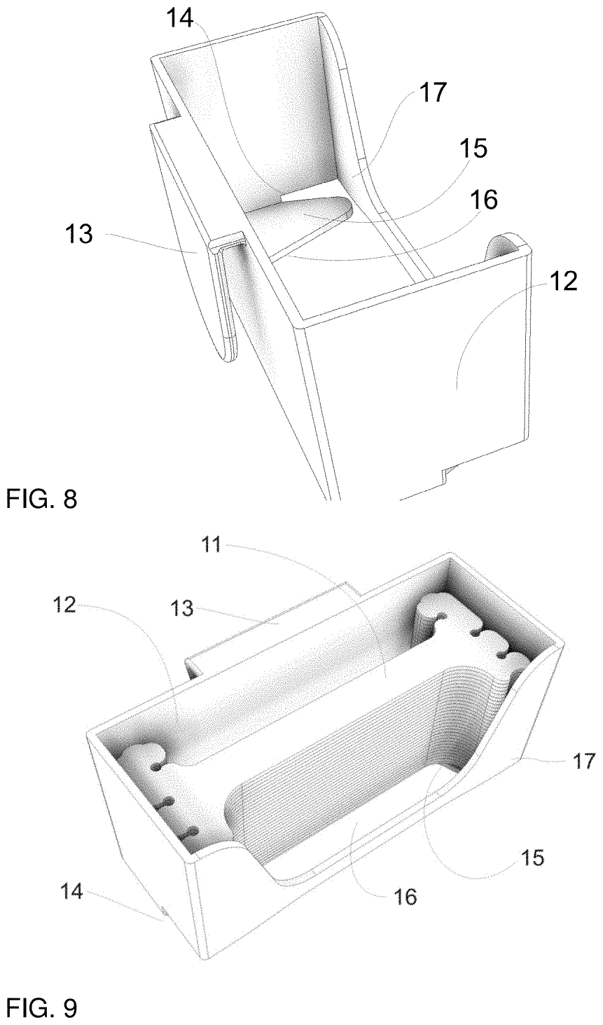

With reference to the drawings, and particularly with references to FIG. 8 which provides a perspective view: As a fastener dispensing unit 12 illustrated without any fasteners. Whereas said dispensing unit has a clip 13 which can be attached to a person's waste band, belt, or other garment on such person.

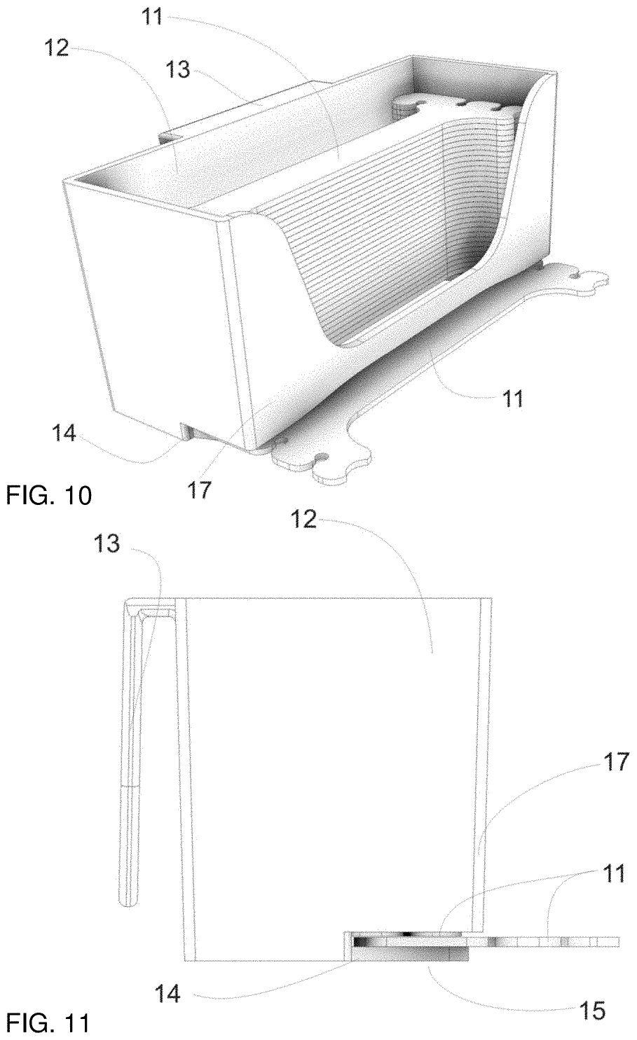

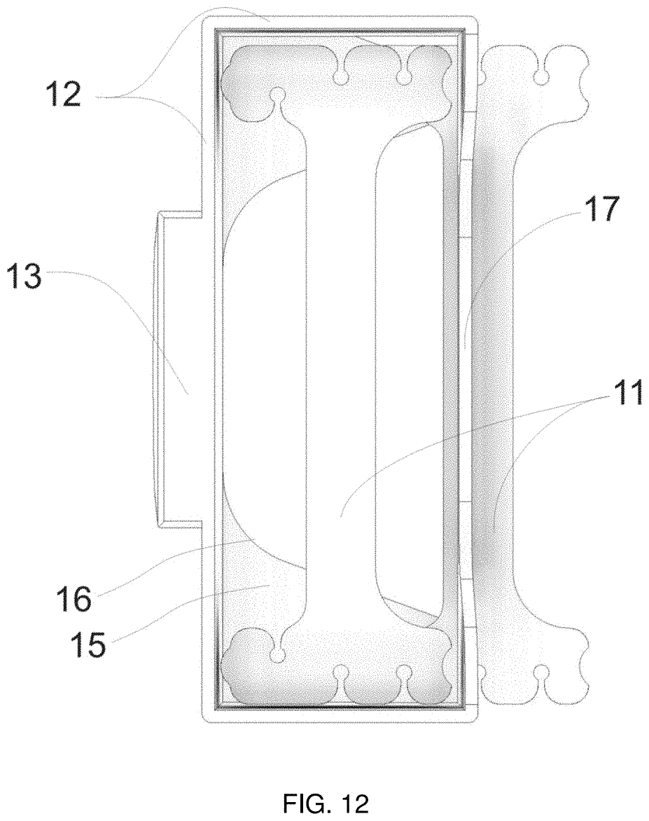

With reference to the drawings, and particularly with references to FIGS. 9, 10, 11, and 12 with respect to the dispensing unit 12 of FIG. 8, wherein FIGS. 9 and 10 are perspective views and FIGS. 11 and 12 are orthogonal views: A stack of fasteners 11 are placed into the dispensing unit 12. The dispensing unit 12 includes a bottom shelf 15 which holds the fasteners in place. The shelf includes a void 16 for allowing a person's fingers to be placed into the bottom of the self and slide a fastener 11 forward. The slot 14 allows for a single fastener to slide forward and restricts other fasteners as they are captured against the front wall 17, therefore allowing removal of the single fastener from the dispensing unit.

Accordingly, there is provided a device for fastening plant material to a support structure, such as a net, trellis, overhead strings, cables, and the like. The device can be a single flat piece of material as shown in FIG. 1, which can be rolled or folding in such a way that two outer wings 7 come in contact with one another in a manner that aligns the left-hand and right-hand mirrored attachment ports 2, 3, and 4 through which the supporting structure can be woven, and the like. Notches 5, and 6 are cut into the outer wings 7 to assist in the alignment, orientation, and placement of the device. The outer wings 7 also can include attachment points of varying number and configuration, advantageously, employed for identifying device alignment, orientation, placement, and the like.

The fastening device is initially relatively planar sheet of material that can be folded, bent, rolled, or otherwise manipulated in a manner such as that the material encompasses, in part or in whole, some portion of the object being contained or supported. The device is constructed from one or more of chipboard, paper, plastic polymer, and the like. The materials can be biodegradable. The materials can be substantially flexible. The materials can be coated with a protective substance, and the like. The center of the device can be a narrow band. The edges of the planar sheet of material can include at least one notch, slot, groove, recess, and the like. The recesses can be positioned for placement of a supporting string, cable, wire, and the like. At least one recess can be positioned for affixing the device to a supporting structure, such as a cage, trellis, net, and the like. At least one recess can be positioned to allow the device to rotate along a horizontal axis, while maintaining the containment of the supporting string, cable, wire, supporting structure, and the like, such as a cage, trellis, net, and the like. The device can include a series of score marks, perforations, and the like. The device can include orientation indicators, including tactile orientation indicators, printed orientation indicators, and the like. One or more devices can be attached to a supporting string, wherein the horizontal rotation of a respective device shortens the vertical distance between each device, aiding in distributing the bearing weight throughout each device. Manufacturing processes can include rotary die cutting, laser die cutting, injection molding, 3D printing, and the like, employing sustainable, compostable, and the like materials.

While the present disclosures have been described in connection with a number of illustrative embodiments, and implementations, the present disclosures are not so limited, but rather cover various modifications, and equivalent arrangements, which fall within the purview of the appended claims.

What is claimed is:

1. A vegetation attachment device, the device comprising:
a foldable, bendable or rollable planar sheet of material with a center portion configured as a narrow band;
edges of the planar sheet of material include one or more of a notch, a slot, a groove, and a recess;
at least one of the recesses is positioned for placement of a supporting string, cable, or wire; and
at least one of the recesses is positioned for affixing to a supporting structure, including one of a cage, a trellis, and a net.

2. The device of claim 1, wherein the planar sheet of material includes one or more of chipboard material, paper material, and plastic polymer material.

3. The device according to claim 1, wherein the planar sheet of material is biodegradable.

4. The device according to claim 1, wherein the planar sheet of material is substantially flexible.

5. The device according to claim 1, wherein the planar sheet of material is coated with a protective substance.

6. The device according to claim 1, wherein at least one of the recesses is positioned to allow the device to rotate along a horizontal axis while maintaining the containment of the supporting string, cable, wire, or supporting structure, such as a cage, trellis, or net.

7. The device of claim 1, wherein the device includes a series of score marks or perforations.

8. The device of claim 1, further comprising:
orientation indicators.

9. The device of claim 8, wherein the orientation indicators are tactile orientation indicators.

10. The device of claim 8, wherein the orientation indicators are printed on the device.

11. The device of claim 1, further comprising:
one or more devices attached to a supporting string, and horizontal rotation of each of the devices shortens a vertical distance between each device, aiding in distributing the bearing weight throughout each device.

12. The device of claim 1, wherein the device is manufactured by one of rotary die cutting, laser die cutting, injection molding, and 3D printing.
